(19) United States
(12) Patent Application Publication
(10) Pub. No.: US 2025/0117427 A1
(43) Pub. Date: Apr. 10, 2025

(54) METHOD AND SYSTEM FOR FACILITATING TRANSFORMING A GRAPH INTO A VECTOR

(71) Applicant: Armand E Prieditis, MCKINLEYVILLE, CA (US)

(72) Inventor: Armand E Prieditis, MCKINLEYVILLE, CA (US)

(21) Appl. No.: 18/376,635

(22) Filed: Oct. 4, 2023

(51) Int. Cl. G06F 16/901; G06F 17/16

(52) U.S. Cl. CPC G06F 16/9024; G06F 16/2237; G06F 16/313

(57) ABSTRACT

During operation, embodiments of the subject matter can transform a graph comprising a weighted adjacency matrix and a node information matrix, into a vector so that the vector can be input into any machine learning method, while maintaining locality and distance-dependent effects.

### BACKGROUND

### Field

The subject matter relates to transforming a graph into a vector.

### Related Art

A graph comprises a non-empty set of nodes, each connected to at least one neighbor node by an edge. A node corresponds to an entity and an edge corresponds to a connection between entities. For example, a molecule can be represented as a graph with atoms as nodes and bonds as edges between pairs of atoms. A social network can be represented as a graph with people as nodes and relationships as edges between pairs of people.

Graphs have many practical applications in bioinformatics, drug development, search engines, document retrieval, chemo-informatics, social network analysis, urban computing, and cyber-security. One application is predicting a property of the graph. For example, predicting whether a molecule is toxic can reduce the time and cost of drug development, which typically involves a large number of expensive assays to measure toxicity—it can cost millions of dollars to test just a few thousand molecules for only a dozen toxic effects.

Classical chemical and genetic screens, which are heavily used in drug screening, suffer from extremely low accuracy (1%-3% hit rates). Machine learning might offer a more accurate and lower cost and time way to predict properties of molecules. However, a machine learning method expects a fixed-order and fixed-length vector as input. In contrast, the nodes and edges of graphs can be provided in any order and a graph can be of any size—any number of nodes and edges.

To address this challenge, Graph Convolutional Networks (GCNs) aggregate the information at each node's set of neighbors and then linearly combine that aggregation with a single-layer neural network. Aggregations include sum, mean, min, and max.

The GCN repeats the same process, each time using the resulting output as an input, until a desired vector size is achieved, which can then be fed into a final neural network. All of the neural networks are trained with backpropagation.

GCNs suffer from three major problems. First, all nodes eventually converge to the same value in the limit of aggregations and linear combinations. This is because the aggregations and linear combinations tend to average the information over all nodes with each update. This averaging destroys locality, which in turn reduces accuracy.

Second, GCNs leverage only one machine learning algorithm to learn the coefficients for each single-layer neural network: back-propagation. GCNs do not leverage other successful machine learning methods, which were developed and honed over decades and which could result in higher accuracy.

Third, because a GCN feeds the output of one aggregation and linear combination into the next, it blurs the distinction between nodes that are close to each other in terms of the number of edges and nodes that are farther away from each other. Blurring of these distance-dependent effects can also result in lower accuracy.

Hence, what is needed is a method and a system for transforming a graph into a vector so that the vector can be input into any machine learning method, while maintaining locality and distance-dependent effects.

### SUMMARY

Embodiments of the subject matter can facilitate transforming a graph, comprising a weighted adjacency matrix and a node information matrix, into a vector so that the vector can be input into any machine learning method, while maintaining locality and distance-dependent effects.

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIG. 1 presents an example system for facilitating transforming a graph into a vector.

In the FIGURES, like reference numerals refer to the same FIGURE elements.

### DETAILED DESCRIPTION

In embodiments of the subject matter, a graph comprises a weighted adjacency matrix, corresponding to the strength of an edge between nodes, and a node information matrix, corresponding to information at each node in the graph. The graph is assumed to contain at least two nodes connected by an edge.

Graphs with a weighted adjacency matrix have many practical applications. They can be used to find an optimal path and a minimum spanning tree in two-dimensional matrix games and transportation networks. They can also be used to represent schedule constraints, precedence orders, asset allocations, and circuit delays, and analyze relevance of web pages and documents. In epidemiology, graphs with a weighted adjacency matrix can be used to find transmission distance from an infected to a healthy person.

In quantum mechanics, graphs with a weighted adjacency matrix can represent quantum states and state transition to find a maximum frequency along a path. In a social network, they can be used to find the strength of connections to find cliques. In computer security, they can be used to predict the spread of worms and criminal activity.

In general, a weighted adjacency matrix can better capture relationships in the real world where the entities (nodes) have different degrees of relationships. A weighted adjacency matrix can also facilitate a more sophisticated analysis involving averages and probabilistic relationships between nodes.

More formally, a graph G=(W, N) where W∈ [symbol] ^{n×n} corresponds to the weighted adjacency matrix with n nodes connected to n nodes, and where N∈ [symbol] ^{n×m} corresponds to a node information matrix with m real-valued (continuous) features at each of the n nodes.

The weighted adjacency matrix W can correspond to the strength of an edge between one node (row) and another node (column). If no connection exists between two nodes, then the strength of a connection can be zero. For example, a weighted adjacency matrix one edge type could correspond to the strength of a bond (e.g., single, double, triple) between atoms in a molecule represented by a graph, where the atoms are nodes in a graph. In the internet, the matrix could correspond to the click-through rate for a link to another website from a particular website, where websites are nodes in a graph. The weighted adjacency matrix W can also correspond to the probability of an edge between one node (row) and another node (column).

The node information matrix N corresponds to information (i.e., a vector) at each node. For example, this matrix could correspond to atom properties (e.g. atomic number, atomic mass) in a molecule represented by a graph. In the internet, the matrix could correspond to website properties (e.g., the frequency of words at a website).

A sparse graph can be represented with methods that are more memory efficient, but these methods are mathematically equivalent to one with weighted adjacency matrix Wand node information matrix N. Henceforth, the assumption is that a weighted adjacency matrix Wand node information matrix N are sufficient to describe a graph, whether or not it is sparse.

Furthermore, the graph might be generated incrementally and embodiments of the subject matter can process the graph incrementally. For example, the graph might correspond to moves in the board game Go, where the moves are generated incrementally.

During operation, embodiments of the subject matter determine W^{k} where k is a positive integer and W^{k} is a matrix product of k copies of W. For example, when k=1, W^{k} corresponds to the strength of direction connections between each node. When k=2, W^{k} corresponds to the strength of connections with nodes that are two hops (edges) away. For example, with a single edge type,

$$W = [ \begin{matrix}0 & 2 & 1 \\ 2 & 0 & 1 \\ 3 & 1 & 0\end{matrix} ]$$

corresponds to a graph with 3 nodes (labeled by indices 1, 2, and 3), where node 1 is connected to node 2 with a strength of 2 and connected to node 3 with a strength of 1; node 2 is connected to node 1 with a strength of 2 and connected to node 3 with a strength of 1; and node 3 is connected to node 1 with a strength of 3 and node 2 with a strength of 1. In this example, the weighted adjacency matrix is not symmetric, meaning that these edges are directed, and nodes do not have self-loops. In general, a weighted adjacency matrix can facilitate any real-valued relationship between nodes, including self-loops (i.e., where elements of the diagonal of W are non-zero).

$${W}^{2} = [ \begin{matrix}7 & 1 & 2 \\ 3 & 5 & 2 \\ 2 & 6 & 4\end{matrix} ] .$$

In this example, Note that this matrix considers the strength of multiple different paths leading to the same node. For example, node A can be adjacent to two other nodes, B and C, which then are each adjacent the same third node D. In that case, the strength between A and D is additive over both paths from A to D.

Once W^{k} has been determined, embodiments of the subject matter multiply W^{k} by N, which results in an n×m matrix. Next, embodiments of the subject matter can aggregate the rows of this n×m matrix to form an m length vector. An m length vector can correspond to an m×1 matrix of continuous values. In some contexts, an m length vector can correspond to an 1×m matrix of continuous values. In either case, this m length vector can be input into a machine learning method, which accepts a fixed-order and fixed-length vector.

Aggregations include, but are not limited to min, mean, max, sum, standard deviation, variance, covariance, median, percentiles, histograms, kurtosis, skewness, and clustering (i.e., distance to each cluster, counts of each cluster as a summary). More generally, an aggregation can combine several numerical values into a single representative value. That is, an aggregation can produce a single number to represent a larger set of data. The aggregation takes into account all the values in that larger set of data. In other words, an aggregation summarizes and provides the gist of the information about the sample data.

Aggregations include but are not limited to descriptive and summary statistics. For example, aggregations include percentiles: given n values, the q-th quantile of those n values is the value q of the way from the minimum to the maximum in a sorted copy of those n values. The five most important percentiles are the sample minimum (smallest observation), the lower quartile or first quartile, the median (the middle value), the upper quartile or third quartile, the sample maximum (largest observation).

Aggregations can include but are not limited to measures of central tendency, measures of variability (dispersion), measures of shape, and measures of association. Measures of central tendency describe the center or typical value of the data, such as the mean, median, interquartile mean, and mode. Measures of variability describe how spread out or dispersed the data are, such as the range, standard deviation, interquartile range, absolute deviation, mean absolute difference and the distance standard deviation, and variance.

Measures of association describe how two or more variables are related to each other, such as correlation, covariance, and contingency tables. Common measures of the shape are skewness, kurtosis, L-moments, and distance skewness, for which a value of zero implies central symmetry. Skewness is a measure of how central the average is in the distribution. Kurtosis is a measure of how pointy the distribution is, how clustered the values are around the middle. Measures that assess spread in comparison to the typical size of data values include the coefficient of variation.

Different aggregations have different strengths and weaknesses. For example, each bin in a histogram has an equal amount of information (one number per bin), regardless of how many points fall into it. In contrast, quantiles can better capture the distributions of high density areas, facilitate variable-density smoothing, and are less sensitive to outliers. But they cannot easily represent disconnected distributions and can have more visual variation than histograms. However, each fraction of data in a quantile has the same amount of information (one number per percentile). In contrast, the mean minimizes the sum of the squared differences between it and each value, but it is sensitive to outliers because of the squaring. In further contrast, the median minimizes the sum of the absolute differences but is less sensitive to outliers.

Embodiments of the subject matter can combine multiple different aggregations such as histograms and quantiles (percentiles) to better summarize the graph and fill in one aggregation's weaknesses with strengths of another aggregation. Multiple such aggregations, in turn, can result in improved accuracy of the machine learning method.

More specifically, each aggregation can result in a vector, which can be concatenated with the vectors of other aggregations to form a larger vector. For example, a mean aggregation results in an m length vector and so does a standard deviation aggregation. These two vectors can then be concatenated together to form an 2m length vector.

Continuing with

$${W}^{2} = [ \begin{matrix}7 & 1 & 2 \\ 3 & 5 & 2 \\ 2 & 6 & 4\end{matrix} ] , if N = [ \begin{matrix}2 & 1 & 9 & 4 \\ 3 & 7 & 4 & 5 \\ 1 & 6 & 9 & 2\end{matrix} ] ,$$

then

$${W}^{2} N = [ \begin{matrix}19 & 26 & 85 & 37 \\ 23 & 50 & 65 & 41 \\ 26 & 68 & 78 & 46\end{matrix} ] .$$

In embodiments of the subject matter, an aggregation can be the mean of each column: [22.66 48 76 41.33].

This aggregation can be combined with vectors of other aggregations such as the standard deviation of the columns. In this example, the standard deviation of the columns results in the following vector: [2.87 17.20 8.29 3.68]. The mean and standard deviation can then be combined to form a larger vector, which can then be input into a machine learning method: [22.66 48 76 41.3 32.87 17.20 8.29 3.68].

Embodiments of the subject matter can functionally combine two or more columns before or after aggregation. Functional combinations include but are not limited to +, −, ×, ÷ and the aforementioned aggregations. For example, one column can be added to another column to create a third column. After this functional combination, the original two columns could be deleted. Such combinations can facilitate reducing the number of features in the resulting vector while potentially improving accuracy of the machine learning method.

Embodiments of the subject matter can determine a vector for each k (number of edge hops) for each type of column aggregation and then combine them together into a vector. An advantage of this approach is that the machine learning method that receives the vector can itself determine how to weight and combine the information coming from each associated k. For example, it may be that a lower k (i.e., less edge hops away) receives a higher weighting based on training data and a particular machine learning method. In other words, it is not necessary to manually determine this weighting—the machine learning method to which the resulting vector is input can automatically determine the weighting for the vectors associated with each of the k hops.

For example, for k∈{1,2,3}, three different vectors can be produced from an aggregation corresponding to the mean of W²N. These can then be concatenated together. In the above example, the mean corresponds to four columns and with k∈{1,2,3}, the concatenated vector will be of length 12 (4×3).

Yet another embodiment of the subject matter can transform a graph with multiple different edge types, each with its own weighted adjacency matrix, into a vector. Each different edge type can result in a different vector, which can then be concatenated together as input to a machine learning method.

For example, embodiments of the subject matter can determine an aggregation that corresponds to a mean for each of the m columns (that mean is determined over the n rows) for each edge type. Each of these results can then be concatenated to form an e×m length vector, which can then be input into a machine learning method. In this situation, the machine learning method can automatically determine the contribution of each edge type, possibly in combination with other edge types.

In yet another embodiment of the subject matter, W^{k} can be normalized in several different ways. Let R be a diagonal matrix of the row sums of W^{k} and let C be a diagonal matrix of the column sums of W^{k}. W^{k} can be normalized as

$${R}^{- 1} {W}^{k} or {R}^{\frac{- 1}{2}} {W}^{k} {R}^{\frac{- 1}{2}} or {R}^{\frac{- 1}{2}} {W}^{k} {C}^{\frac{- 1}{2}} .$$

These normalized versions can result in greater generalization but possibly at the cost of accuracy.

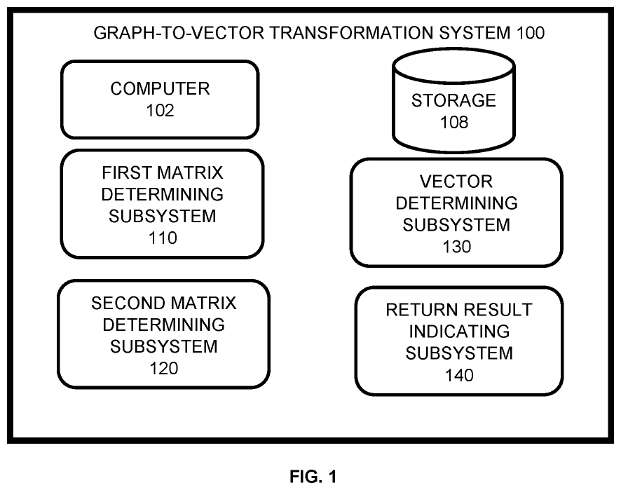

FIG. 1 shows an example graph-to-vector transformation system 100 in accordance with an embodiment of the subject matter. Graph-to-vector transformation system 100 is an example of a system implemented as a computer program on one or more computers in one or more locations (shown collectively as computer 102), with one or more storage devices (shown collectively as storage 108), in which the systems, components, and techniques described below can be implemented. The graph comprises a weighted adjacency matrix and a node information matrix, as described above. The vector is a fixed-length ordered list of real-values.

During operation, graph-to-vector transformation system 100 determines a first matrix based on a product of two or more copies of the weighted adjacency matrix with first matrix determining subsystem 110. Next, graph-to-vector transformation system 100 determines a second matrix based on a product of the first matrix and the node information matrix with second matrix determining subsystem 120. Subsequently, graph-to-vector transformation system 100 determines the vector based on an aggregation of the second matrix with vector determining subsystem 130. Next, graph-to-vector transformation system 100 returns a result indicating the vector with return result indicating subsystem 140.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and

interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions. The processor and the memory can be supplemented by, or

incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating transforming a graph, comprising a weighted adjacency matrix and a node information matrix, into a vector, the computer-implemented method comprising:
determining a first matrix based on a product of two or more copies of the weighted adjacency matrix,
determining a second matrix based on a product of the first matrix and the node information matrix,
determining the vector based on an aggregation of the second matrix, and returning a result indicating the vector.

2. The method of claim 1,
wherein the aggregation of the second matrix comprises determining a mean for each column of the second matrix.

3. The method of claim 1,
wherein the aggregation of the second matrix comprises determining a standard deviation for each column of the second matrix.

4. The method of claim 1,
wherein the aggregation of the second matrix comprises determining a sum for each column of the second matrix.

5. The method of claim 1,
wherein the aggregation of the second matrix comprises determining a covariance matrix between each pair of columns of the second matrix.

6. The method of claim 1,
wherein the aggregation of the second matrix comprises determining a percentile for each column of the second matrix.

7. The method of claim 1,
wherein the aggregation of the second matrix comprises determining a functional combination of two or more columns.

8. One or more non-transitory computer-readable storage media storing instructions that when executed by one or more computers cause the one or more computers to perform operations for facilitating transforming a graph, comprising a weighted adjacency matrix and a node information matrix, into a vector, comprising:
determining a first matrix based on a product of two or more copies of the weighted adjacency matrix,
determining a second matrix based on a product of the first matrix and the node information matrix,
determining the vector based on an aggregation of the second matrix, and returning a result indicating the vector.

9. The one or more non-transitory computer-readable storage media of claim 8,
wherein the aggregation of the second matrix comprises determining a mean for each column of the second matrix.

10. The one or more non-transitory computer-readable storage media of claim 8,
wherein the aggregation of the second matrix comprises determining a standard deviation for each column of the second matrix.

11. The one or more non-transitory computer-readable storage media of claim 8,
wherein the aggregation of the second matrix comprises determining a sum for each column of the second matrix.

12. The one or more non-transitory computer-readable storage media of claim 8,
wherein the aggregation of the second matrix comprises determining a covariance matrix between each pair of columns of the second matrix.

13. The one or more non-transitory computer-readable storage media of claim 8,
wherein the aggregation of the second matrix comprises determining a percentile for each column of the second matrix.

14. A system comprising one or more computers and one or more storage devices storing instructions that when executed by the one or more computers cause the one or more computers to perform operations for facilitating transforming a graph, comprising a weighted adjacency matrix and a node information matrix, into a vector, comprising:
determining a first matrix based on a product of two or more copies of the weighted adjacency matrix,
determining a second matrix based on a product of the first matrix and the node information matrix,
determining the vector based on an aggregation of the second matrix, and returning a result indicating the vector.

15. The system of claim 14,
wherein the aggregation of the second matrix comprises determining a mean for each column of the second matrix.

16. The system of claim 14,
wherein the aggregation of the second matrix comprises determining a standard deviation for each column of the second matrix.

17. The system of claim 14,
wherein the aggregation of the second matrix comprises determining a sum for each column of the second matrix.

18. The system of claim 14,
wherein the aggregation of the second matrix comprises determining a covariance matrix between each pair of columns of the second matrix.

19. The system of claim 13,
wherein the aggregation of the second matrix comprises determining a percentile for each column of the second matrix.

20. The system of claim 13,
wherein the aggregation of the second matrix comprises determining a functional combination of two or more columns.
